(19) United States
(12) Patent Application Publication
(10) Pub. No.: US 2006/0228468 A1
(43) Pub. Date: Oct. 12, 2006

(54) Process for producing an electrode

(76) Inventors: Jonathan Michael Lain, Abingdon, Oxfordshire (GB); Ian McDonald, Wantage, Oxfordshire (GB); David Paul Blackmore, Abingdon, Oxfordshire (GB); Vijay Dass, Oxford, Oxfordshire (GB); Yuan Gao, Monroe, NJ (US)

Correspondence Address: LAW OFFICES OF WILLIAM H. HOLT, 12311 HARBOR DRIVE, WOODBRIDGE, VA, 22192, US

(21) Appl. No.: 10/568,067

(22) PCT Filed: Aug. 9, 2004
(86) PCT No.: PCT/GB04/03443

§ 371 Date: Jun. 8, 2006

(30) Foreign Application Priority Data
Aug. 13, 2003 (GB) 0318942.0

(51) Int. Cl. B05D 5/12; B05D 3/00

(52) U.S. Cl. 427/123; 427/383.1

(57) ABSTRACT

A process for producing an electrode which comprises forming an electrode precursor comprising a layer comprising an intercalation material, and then applying stabilised lithium metal particles to the surface of the electrode precursor.

The present invention relates to a process for producing an electrode and electrodes produced by that process, a process for producing a separator for a cell and separators produced by that process and cells comprising the electrodes and/or separators.

For many years it has been known to make cells with lithium metal anodes, and cathodes of a material into which lithium ions can be intercalated or inserted. Such cells may use, as electrolyte, a solution of a lithium salt in an organic liquid such as propylene carbonate, and a separator such as filter paper or polypropylene. More recently the use of a solid-state ion-conducting polymer has also been suggested as an electrolyte. For secondary or rechargeable lithium cells, the use of lithium metal anodes is unsatisfactory as problems arise from dendrite growth and electrolyte decomposition on freshly deposited lithium. The elimination of this problem is now possible by employing a material able to intercalate lithium ions reversibly at very low voltages, such as graphite, leading to so-called “lithium-ion”, “rocking-chair”, or “swing” lithium rechargeable batteries. These lithium cells operate on the principle that they contain not lithium metal, but lithium ions which are rocked back and forth between two intercalation materials during the charging and discharging parts of the cycle.

Conventional lithium ion cell technology uses a carbon composite anode and a lithium metal oxide (usually cobalt) composite cathode. During the formation cycle (first charge), a solid electrolyte interface (SEI) layer is produced on the surface of the carbon particles. This layer greatly diminishes any further electrochemical reduction of the electrolyte, and allows the cell to operate for hundreds of cycles. However, producing the SEI layer consumes some of the lithium from the cathode. This lithium is no longer available for reaction, and is termed the irreversible capacity of the anode.

US 2002/0119373 discloses the use of finely divided lithium powder in the anode of a cell. This has the advantage of compensating for the irreversible capacity of the anode due to the formation of the solid electrolyte interface.

However, the stabilised lithium powder disclosed in US 2002/0119373 reacts with solvents that are typically preferred for cell fabrication. In particular it is not compatible with N-methylpyrrolidinone (NMP), dimethyl formamide (DMF), and dimethyl acetamide (DMA) which are the preferred solvents for the preferred binder polyvinylidene fluoride (PVdF). Styrene butadiene rubbers and other similar binders may also be used in lithium ion cell anodes. These materials are commonly used as an aqueous suspension. When used as an aqueous suspension, these binders are also incompatible with stabilised lithium powder, as the powder reacts with water.

It is therefore necessary to find an alternative way of incorporating lithium powder into a cell.

Accordingly, the present invention provides a process for producing an electrode which comprises forming an electrode precursor comprising a layer comprising an intercalation material, and then applying stabilised lithium metal particles to the surface of the electrode precursor. The present invention also provides an electrode comprising an intercalation material and a surface coating of stabilised lithium metal particles.

The electrode precursor is made of a material into which the stabilised lithium metal particles intercalate at some point in the charging and discharging cycle of the cell. The electrode that is formed may be a cathode or an anode. Where the electrode is an anode, the intercalation material is a material which has a low voltage relative to lithium, for example one or more of carbonaceous materials, silicon, silicon containing materials such as silicon dispersed in carbon, tin, tin oxides, composite tin alloys, and lithium metal nitrides. When the cell is charged lithium intercalates into the material of the anode. Where the electrode is a cathode the material is one or more of lithium metal oxides and lithium metal phosphates such as LiCoO₂, LiMn₂O₄ and LiFePO₄. Other possible materials include V₆O₁₃ and LiV₃O₈. When a cell is formed containing such a cathode, lithium first de-intercalates from the cathode as the cell is charged and then re-intercalates into the cathode as the cell discharges.

The particles are preferably a finely divided powder, more preferably particles with a mean particle size of less than about 20 μm.

The particles are stabilised lithium metal particles. In one embodiment of the present invention the particles are a mixture of stabilised lithium metal particles and another material, such as a mixture of lithium particles and carbon particles. Methods for producing stabilised lithium metal particles are described in U.S. Pat. No. 5,567,474, U.S. Pat. No. 5,776,369 and U.S. Pat. No. 5,976,403.

The stabilised lithium metal particles may provide all of the lithium required by the cell. However as lithium has a low density it would tend to require a relatively thick surface layer to provide all of the lithium in this manner. Alternatively, the lithium particles may provide only some of the lithium provided by the cell, for example to compensate for the irreversible capacity of the anode.

The stabilised lithium metal particles may be applied to the surface of any type of electrode precursor such as a composite electrode precursor formed from a mixture comprising an active material, binder, and solvent, an extruded electrode precursor comprising an active material and binder/adhesive but no solvent, an electrode precursor formed by electrodeposition from a plating solution or an electrode precursor formed by surface coating techniques such as sputtering or chemical vapour deposition. Where the electrode precursor is a composite electrode precursor formed from a mixture comprising an active material, binder, and solvent then the preferred active material is a carbonaceous material such as carbon, the preferred binder is PVdF and the preferred solvents are N-methylpyrrolidinone (NMP), dimethyl formamide (DMF), and dimethyl acetamide (DMA).

Typically, the stabilised lithium metal particles are applied to the surface of the electrode precursor such that they are in electrical contact with the intercalation material.

The process for preparing a conventional carbon composite anode typically takes the following general form. Carbon(s), binder and solvent are mixed together to achieve a uniform mix. The mixture is pattern coated onto thin copper foil, with controlled evaporation of the solvent. The electrode is then dried (this may optionally take the form of vacuum drying). The electrode is then calendered to achieve the required electrode porosity and then slit to the required electrode width. It is then vacuum dried, often at raised temperature and then stored, usually as electrode reels (often vacuum packed), until required for cell construction.

The stabilised lithium metal particles may be applied to the surface of a conventional carbon composite anode (electrode precursor) at any suitable point during the preparation of the electrode precursor, preferably at any point after removal of the coating solvent. However, it is preferable to apply the particles after the electrode precursor has been dried for the second time. This has various practical advantages. For example, calendering and slitting machines are not usually situated in areas with dry air, and wet air will start to hydrolyse the lithium particles. In addition, slitting generates waste material at the edges and ends of the coated material. If the whole reel is coated with particles, then those on the off-cuts are wasted. Further, calendering the electrode precursor uses quite high pressures, whereas particles, and in particular lithium particles, only need light pressure to stick them to the electrode precursor. Although the particles will be integrated more uniformly into the electrode by calendering, the higher pressure may crack open the stabilising layer of the stabilised lithium particles. This may lead to the lithium particles reacting as the freshly exposed lithium surfaces are very reactive. In addition, the particles may tend to stick to the metallic rollers of the calendaring machine, making it difficult to control the quantity added, and requiring the rollers to be cleaned regularly.

The stabilised lithium metal particles may be applied by any suitable method. Suitable ‘wet’ methods include spray coating of particles dispersed in liquid, metered pumping of a particle dispersion onto the electrode surface, metered pumping of a particle dispersion using dissolved polymer to aid dispersion and particle adhesion, transfer roller coating using a particle dispersion or suspension, screen printing of the particles dispersed in an ‘ink’, wet casting using “knife over plate” or “knife over roll”, rotogravure or anilox roll coating, extrusion or slot-die coating (low pressure extrusion of a mixture of liquid and particles). Preferably the particles are applied suspended in a liquid or are applied as a slurry or suspension. Suitable ‘dry’ methods include electrostatic transfer, cascade rolling of dry particles, or sprinkling the particles onto the electrode precursor surface using a sieve or ‘pepper-pot’ apparatus. Electrostatic transfer is a preferred ‘dry’ method.

After application the stabilised lithium metal particles are typically fixed using light rolling. A protective sheet is usually required between the rollers and the electrode to prevent the particles from sticking to the rollers.

The stabilised lithium metal particles may be applied to the surface of the electrode precursor so as to form a continuous or non-continuous coating. For example, the particles may be applied so as to cover only portions of the electrode precursor.

Ideally, the stabilised lithium metal particles are applied so as to form a coating of uniform thickness. Thus, in a preferred embodiment of the present invention, the anode of the present invention has a surface coating of stabilised lithium metal particles of uniform thickness.

A cell typically comprises at least an anode, cathode and an electrolyte. If the electrolyte is a liquid then, to ensure separation, a separator is generally provided between the anode and the cathode in the cell. The separator may be a porous inert sheet for example of glass fibre, polypropylene, or polyethylene. Alternatively, the separator is a polymeric sheet that forms a gel-like layer when impregnated by a non-aqueous solvent that acts as a plasticiser; desirably the sheet is microporous. A suitable polymeric sheet comprises a polymer such as polyvinylidene fluoride (PVdF), or a copolymer of vinylidene fluoride with hexafluoropropylene (PVdF/HFP).

The stabilised lithium metal particles may also be applied to the separator in the same way as to the electrode precursor where a separator is used in a cell. Accordingly, the present invention provides a process for producing a separator for use in a cell comprising an intercalation material which process comprises forming a separator precursor and applying stabilised lithium metal particles to the surface of the separator precursor. The present invention also provides a separator for use in a cell comprising an intercalation material which separator comprises a separator precursor and a surface coating of stabilised lithium metal particles.

The separator precursor may be made of any suitable separator material including those described above.

The present invention also provides a cell comprising an electrode and/or separator of the present invention and a battery incorporating one or more cells of the present invention.

One advantage of the present invention is that the stabilised lithium metal particles applied to the electrode precursor or separator precursor can compensate for the irreversible capacity of the cell, for example where the particles comprise lithium particles.

Specific constructions of cells comprising electrodes embodying the invention will now be described by way of example and with reference to the drawings filed herewith, in which:

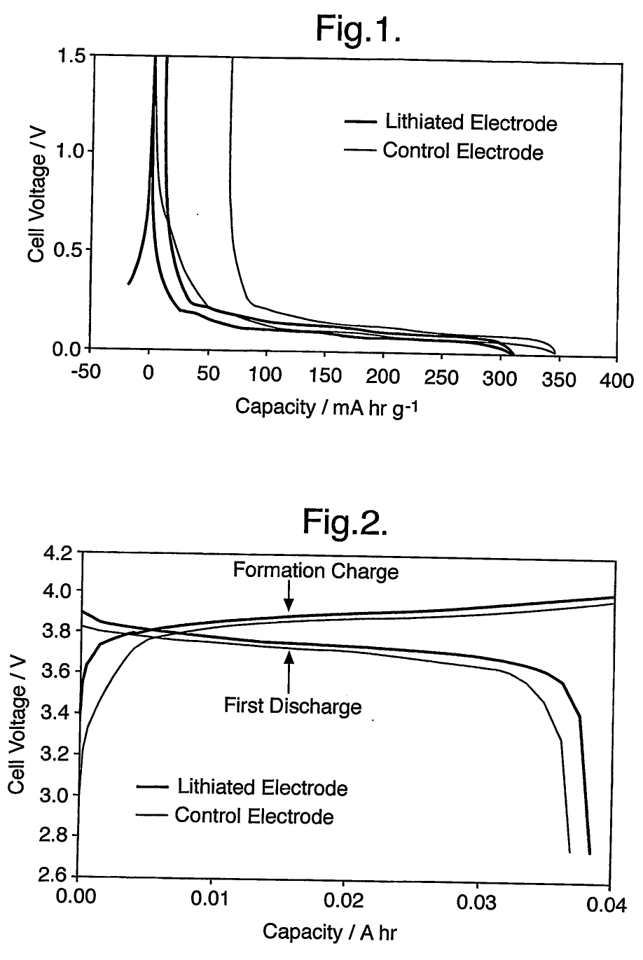

FIG. 1 illustrates the cell voltages during the charge and discharge cycle for the cells of example 1.

FIG. 2 illustrates the cell voltages during formation and first discharge for the cells of example 2.

The present invention is now described in greater detail by way of example.

### EXAMPLE 1

A lithium ion anode containing 91.5% carbon and 8.5% PVdF was coated on 10 μm copper foil, using standard mixing and coating processes. A 40 mm diameter disc was cut from the calendered electrode, and placed in a glass beaker. Approximately 20 mg of stabilised lithium powder was weighed out into the beaker, and p-xylene was added to make a slurry. The lithium was dispersed over the electrode, and the xylene was allowed to evaporate. After drying overnight in a vacuum oven at room temperature, the electrode was rolled lightly between two pieces of release paper. The lithium powder was visible on the electrode surface, and the electrode weight had increased by 3.19 mg. The weight of carbon in the electrode was 105 mg. The lithium:carbon molar ratio was therefore around 0.05:1.

Discs were cut from the electrode with a 12.46 mm diameter cutter, and assembled into half cells with lithium metal counter and reference electrodes. The electrolyte was 1.2 M LiPF₆ in a mixture of ethylene carbonate:ethyl methyl carbonate (2:8). The cells were cycled between 1.5 V and 0.005 V vs. Li/Li⁺, using a current of +0.2 mA. As a control, electrodes were also cut from the original coated material, and assembled into half cells. The cell voltages during the initial charge and discharge cycle for one test cell and one control cell are shown in FIG. 1.

The initial voltage of the test cell was 0.317 V vs. Li/Li⁺, compared to 2.712 V for the control cell. Lithium could also be extracted from the electrode in the test cell, before the initial charge. The coulombic efficiency during the first cycle was 96.9% for the test cell, and 81.2% for the control cell. The capacity at around 0.8 V vs. Li/Li⁺ that is associated with forming the SEI layer was absent in the test cell.

FIG. 1 shows the initial charge and discharge of the test cell and the control cell. The control cell had an initial voltage of 2.712 V at a capacity of 0. As the cell was charged the capacity increased and the voltage decreased. This is due to the insertion of lithium into the anode. Once the voltage reached 5 mV the process was reversed and the cell was discharged. During this process lithium moved out of the anode. At a capacity of about 70 mA hr g⁻¹ the voltage suddenly increased. This was due to no more lithium being available. The difference in capacity between the uncharged cell and the discharged cell was due to the irreversible capacity of the cell. In contrast, for the test cell the initial voltage was about 0.3 V. This was due to some prelithiation of the anode by the lithium powder. Lithium was removed from the anode by discharging the cell. A charging and discharging cycle was then performed in the same way as for the control cell. The voltage dropped to 5 mV earlier due to the fact that the solid electrolyte interface layer was already formed at the beginning of the experiment. However the capacity of the cell when discharged was much closer to that of the cell before charging started. This indicates that all the lithium that intercalated in to the anode on charging was also released by the anode on discharging. Thus, no lithium from the cathode was used to form the SEI layer as this was provided by the lithium powder. The small difference in capacity is likely to be due to internal resistance of the cell. These results all suggest that the lithium powder reacted to form an SEI layer on the carbon particles.

### EXAMPLE 2

Commercial lithium ion anode and cathode electrode materials were obtained from AGM Batteries Ltd., Thurso, Scotland. The anode was graphite/PVdF on copper foil, and the cathode was lithium cobalt oxide/carbon/PVdF on aluminium foil. Both electrodes had been calendered. The coating was removed from one side of each electrode, using N-methylpyrrolidinone and gentle scraping. Smaller electrodes were then cut from each sheet; 32×51 mm for the anode and 30×49 mm for the cathode.

For the test cells, a measured quantity of lithium powder was applied to the surface of the anode. A mixture of stabilised lithium powder and carbon was dispersed in p-xylene, and a number of drops were applied using a syringe. The xylene was then allowed to evaporate before cell construction. The anodes in the control cells were not treated in any way.

One anode and one cathode were wrapped in a porous separator, and assembled into a soft pack cell. The cell was designed for a stack of several electrodes, so a plastic spacer was used to fill up the void space. The electrolyte was 1.2 M LiPF₆ in a mixture of ethylene carbonate:ethyl methyl carbonate (2:8). The cells were allowed to soak for around two hours, and then charged at 12 mA up to a capacity of 40 mA hr. After being left for three days to age, the cells were discharged at 8 mA down to 2.75 V. FIG. 2 shows the charge and discharge voltages for one test cell and one control cell, during the initial cycle.

The voltage of the test cell before formation (first charge) was 2.733 V, compared to 0.010 V for the control cell. The test cell reached a higher voltage during formation, implying a higher state of charge. Charging of each cell stopped at a capacity of 0.04 A hr. The cells were then discharged. The test cell started at a higher voltage and produced more capacity during this subsequent discharge. This is shown in FIG. 2. The coulombic efficiencies for this first cycle were 95.8% for the test cell, and 92.0% for the control cell. These results all suggest that the lithium powder reacted to form an SEI layer on the carbon particles.

1. A process for producing an electrode which comprises forming an electrode precursor comprising a layer comprising an intercalation material, and then applying stabilised lithium metal particles to the surface of the electrode precursor.

2. A process according to claim 1 wherein the particles are applied to the anode.

3. A process according to claim 1 wherein the particles are suspended in a liquid for application to the electrode precursor.

4. A process according to claim 1 wherein the particles are formed into a slurry or suspension and dispersed over the electrode precursor.

5. A process according to claim 1 wherein the particles are applied by electrostatic transfer.

6. A process according to claim 1 wherein the particles are fixed to the electrode surface by rolling.

7. A process according to claim 1 wherein the stabilised lithium metal particles are mixed with carbon particles.

8. A process according to claim 1 wherein the electrode precursor is a composite electrode precursor comprising an active material and a binder, and prepared using a solvent for the binder.

9. A process according to claim 8 wherein the active material is carbon.

10. A process according to claim 8 wherein the binder is polyvinylidene fluoride (PvdF).

11. A process according to claim 8 wherein the process for producing the electrode precursor comprises the steps of
i) mixing the active material, binder and solvent together to achieve a uniform mix
ii) coating the mixture onto a thin copper foil, with controlled evaporation of the solvent
iii) drying the electrode
iv) calendaring the electrode, and
v) vacuum drying the electrode,
before applying the stabilised lithium metal powder to the electrode precursor.

12. An electrode comprising an intercalation material and a surface coating of stabilised lithium metal particles.

13. A process for producing a separator for use in a cell comprising an intercalation material which process comprises forming a separator precursor and applying stabilised lithium metal particles to the surface of the separator precursor.

14. A process according to claim 13 wherein the particles are suspended in a liquid for application to the separator precursor.

15. A process according to claim 13 wherein the particles are formed into a slurry or suspension and dispersed over the separator.

16. A process according to claim 13 wherein the particles are applied by electrostatic transfer.

17. A separator for use in a cell comprising an intercalation material which separator comprises a separator precursor and a surface coating of stabilised lithium metal particles.

18. A cell comprising an electrode produced according to claim 1.

19. A cell comprising an electrode according to claim 12.

20. A cell comprising a separator produced according to claim 13.

21. A cell comprising a separator according to claim 17.

22. A battery comprising one or more cells according to claim 18.
